(19) United States
(12) Patent Application Publication
(10) Pub. No.: US 2021/0048241 A1
(43) Pub. Date: Feb. 18, 2021

(54) ROTATING SHELF ASSEMBLY AND METHOD OF OPERATION

(71) Applicant: Haier US Appliance Solutions, Inc., Wilmington, DE (US)

(72) Inventors: Louis A. Wantland, Louisville, KY (US); Bagawathkumar Chellappan, Prospect, KY (US)

(21) Appl. No.: 16/540,161

(22) Filed: Aug. 14, 2019

(51) Int. Cl. F25D 29/00; F25D 25/02; G05B 19/042

(52) U.S. Cl. CPC F25D 29/003; F25D 25/027; G05B 2219/25252; F25D 2325/021; G05B 19/042

(57) ABSTRACT

A rotating shelf assembly includes a shelf and a rotating disk rotatably mounted to the shelf and driven by a drive mechanism, such as an electric motor and gear assembly. A controller is configured for operating the drive mechanism to rotate the rotating disk to a desired angular position in response to an external stimulus or position parameter, such as a user, outside weather data, food quality, time/date, etc.

### FIELD OF THE INVENTION

The present subject matter relates generally to rotating shelf assemblies, and more particularly to smart shelf assemblies for refrigerator appliances.

### BACKGROUND OF THE INVENTION

Refrigerator appliances generally include a cabinet that defines a chilled chamber for receipt of food articles for storage. In addition, refrigerator appliances include one or more doors rotatably hinged to the cabinet to permit selective access to food items stored in chilled chamber(s). The refrigerator appliances can also include various storage components mounted within the chilled chamber and designed to facilitate storage of food items therein. Such storage components can include racks, bins, shelves, or drawers that receive food items and assist with organizing and arranging of such food items within the chilled chamber.

However, food items placed on shelves in the chilled chamber are often difficult to view or access, particularly when placed near the back of the shelf. For example, due to the width and depth of conventional refrigerators and the fact that the shelves are typically fixed within the chilled chamber, a user must often reach deep into the chilled chamber to access items. Moreover, large items can obstruct or impede storage and access of smaller food items within the chilled chamber. Therefore, a user may need to remove items on the front of the shelf in order to reach items on the back of the shelf. These difficulties lead to consumer frustration and discomfort when placing items in or removing items from the chilled chamber. In addition, conventional refrigerator appliances do not have features that are designed to present or suggest particular items to a user for consumption or use.

Accordingly, a refrigerator appliance with features for improving storage of and access to food items stored within the chilled chamber of the refrigerator appliance would be useful. More particularly, a rotating shelf assembly that rotates to a particular position to present a user with a particular item based on an external stimulus would be particularly beneficial.

### BRIEF DESCRIPTION OF THE INVENTION

Aspects and advantages of the invention will be set forth in part in the following description, or may be apparent from the description, or may be learned through practice of the invention.

In a first exemplary embodiment, a rotating shelf assembly is provided including a shelf, a rotating disk rotatably mounted to the shelf, and a drive mechanism mechanically coupled to the rotating disk for selectively rotating the rotating disk. A controller is operably coupled to the drive mechanism for obtaining a position parameter indicative of a desired shelf position of the rotating disk. The controller also determines, based on the position parameter, the desired shelf position, and operates the drive mechanism to rotate the rotating disk to the desired shelf position.

According to another exemplary embodiment, a method of operating a rotating shelf assembly is provided. The rotating shelf assembly includes a rotating disk rotatably mounted to a shelf and being mechanically coupled to a drive mechanism. The method includes obtaining a position parameter indicative of a desired shelf position of the rotating disk. The method further includes determining, based on the position parameter, the desired shelf position, and operating the drive mechanism to rotate the rotating disk to the desired shelf position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an exemplary embodiment of the present subject matter.

FIG. 2 provides a perspective view of the exemplary refrigerator appliance of FIG. 1, with the doors of the fresh food chamber shown in an open position.

FIG. 3 provides a perspective view of a rotating shelf assembly that may be used in the exemplary refrigerator appliance of FIG. 1 according to another exemplary embodiment of the present subject matter.

FIG. 4 provides a bottom perspective view of the exemplary rotating shelf assembly of FIG. 3.

FIG. 5 provides an exploded perspective view of the exemplary rotating shelf assembly of FIG. 3.

FIG. 6 provides a side cross sectional perspective view of the exemplary rotating shelf assembly of FIG. 3.

FIG. 7 depicts certain components of a controller according to example embodiments of the present subject matter.

FIG. 8 illustrates a method for operating a rotating shelf assembly according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

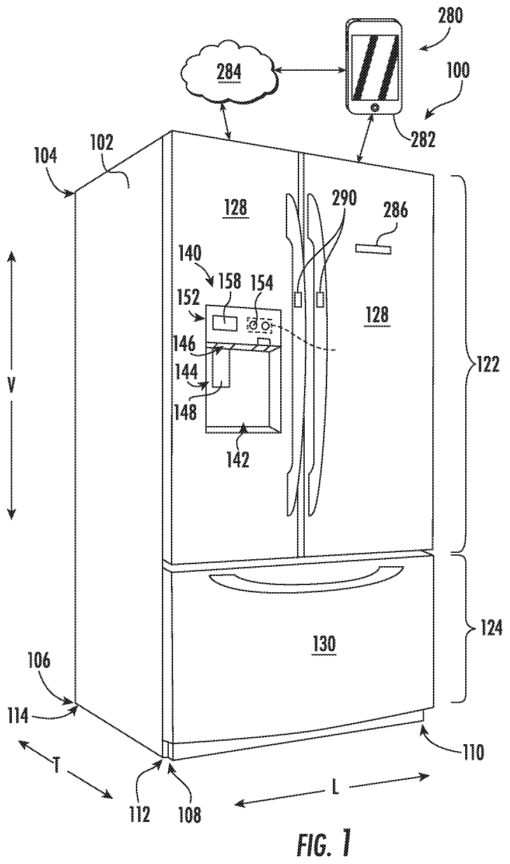

FIG. 1 provides a perspective view of a refrigerator appliance 100 according to an exemplary embodiment of the present subject matter. Refrigerator appliance 100 includes a cabinet or housing 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another.

Housing 102 defines chilled chambers for receipt of food items for storage. In particular, housing 102 defines fresh food chamber 122 positioned at or adjacent top 104 of housing 102 and a freezer chamber 124 arranged at or adjacent bottom 106 of housing 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well, such as ovens, microwaves, etc. Consequently, the description set forth herein is for illustrative purposes only and is not intended to be limiting in any aspect to any particular appliance or configuration.

Refrigerator doors 128 are rotatably hinged to an edge of housing 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. Refrigerator doors 128 and freezer door 130 are shown in the closed configuration in FIG. 1. One skilled in the art will appreciate that other chamber and door configurations are possible and within the scope of the present invention.

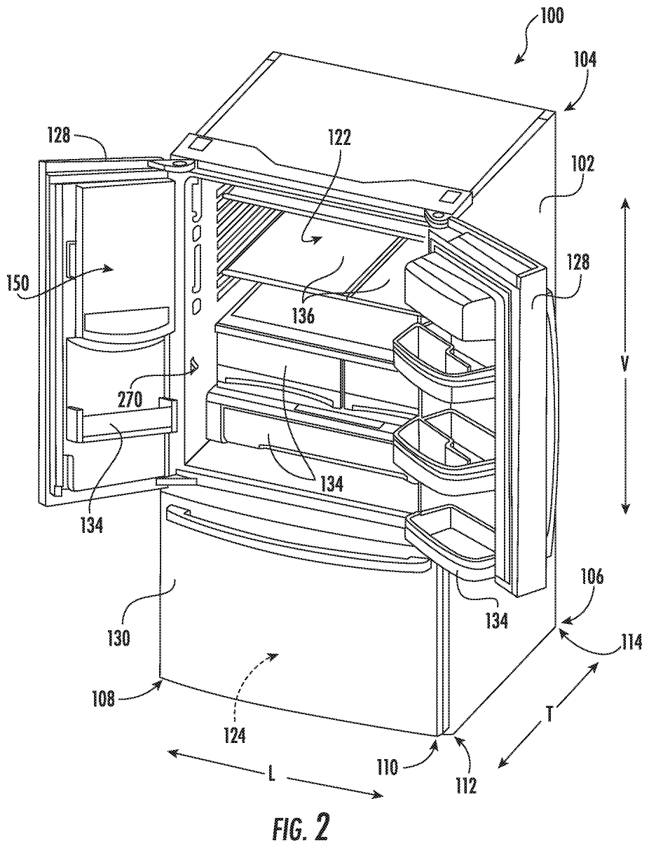

FIG. 2 provides a perspective view of refrigerator appliance 100 shown with refrigerator doors 128 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components are configured for receipt of food items (e.g., beverages and/or solid food items) and may assist with organizing such food items. As illustrated, bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142. By contrast, refrigerator door 128 may define an icebox compartment 150 (FIG. 2) housing an icemaker and an ice storage bin (not shown) that are configured to supply ice to dispenser recess 142.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As described in more detail below with respect to FIG. 7, “processing device” or “controller” may refer to one or more microprocessors or semiconductor devices and is not restricted necessarily to a single element. The processing device can be programmed to operate refrigerator appliance 100, dispensing assembly 140 and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

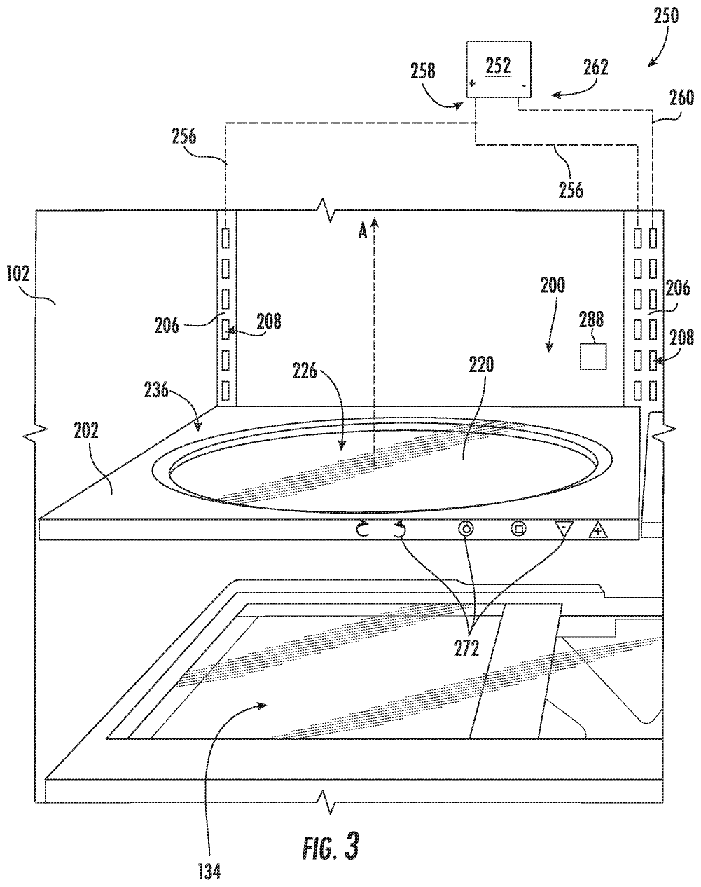

Referring now generally to FIGS. 3 through 6, a rotating shelf assembly 200 which may be used with refrigerator appliance 100 will be described according to exemplary embodiments of the present subject matter. Specifically, rotating shelf assembly 200 may be used in place of one or more of shelves 136 of refrigerator appliance 100. In addition, rotating shelf assembly 200 may be used in place of a top wall of one or more bins 134. Alternatively, rotating shelf assembly 200 may be used in any other suitable refrigerator appliance or in any other application where a rotating shelf may be desirable. Indeed, according to exemplary embodiments, rotating shelf assembly 200 may be a freestanding shelf positioned on a countertop, within a pantry or cabinet, or at any other suitable location. The exemplary embodiments and applications described herein are not intended to limit the scope of the present subject matter in any manner.

As illustrated, rotating shelf assembly 200 generally includes a shelf 202 positioned within a chilled chamber of refrigerator appliance 100, e.g., in fresh food chamber 122. In this regard, shelf 202 may be any suitably rigid component extending substantially along a horizontal direction (e.g., as defined by the lateral direction L and the transverse direction T) for receiving one or more food items or articles for storage. In this regard, for example, shelf 202 may be constructed in whole or in part from glass, e.g. such as acrylic glass, plastic, or any other suitably rigid materials or combinations thereof.

Rotating shelf assembly 200 further includes one or more shelf support brackets 204 that are mounted to cabinet 102 and are configured for supporting shelf 202 and food items positioned thereon. For example, according to the illustrated embodiment, each shelf 202 is supported by two shelf support brackets 204 that extend along the transverse direction T from rear side 114 of cabinet 102 in a cantilevered manner. Alternatively, shelf support brackets 204 may extend from first side 108 and/or second side 110 of cabinet 102, and may not be cantilevered according to alternative embodiments. According to the illustrated embodiment, shelf support brackets 204 constructed of a rigid material, such as metal, for supporting the weight of shelves 202.

In addition, refrigerator appliance 100 may further include track support systems for removably receiving shelf support brackets 204. Specifically, as illustrated in FIG. 3, track support systems may include a plurality of vertical support tracks 206 that extend along the vertical direction V and are mounted to rear side 114 of cabinet 102. Each vertical support track 206 may define a plurality of apertures 208 which generally define a plurality of mounting positions to which shelf support brackets 204 may be mounted. In this manner, a user of refrigerator appliance 100 may remove shelf support brackets 204 and move them to any suitable vertical position before reattaching them to vertical support tracks 206.

Referring still generally to FIGS. 3 through 6, rotating shelf assembly 200 further includes a rotating disk 220 that is rotatably mounted to shelf 202. In this regard, rotating disk 220 may be a circular plate constructed from any suitably rigid material. For example rotating disk 220 may be a transparent, translucent, or semi-transparent pane of glass, acrylic, plastic, or other suitable material. Rotating disk 220 is generally configured for receiving food items for storage within the chilled chamber while facilitating improved access and visibility to such food items. Specifically, a user may reach items positioned proximate rear side 114 of cabinet 102 simply by spinning rotating disk 220 around approximately 180 degrees.

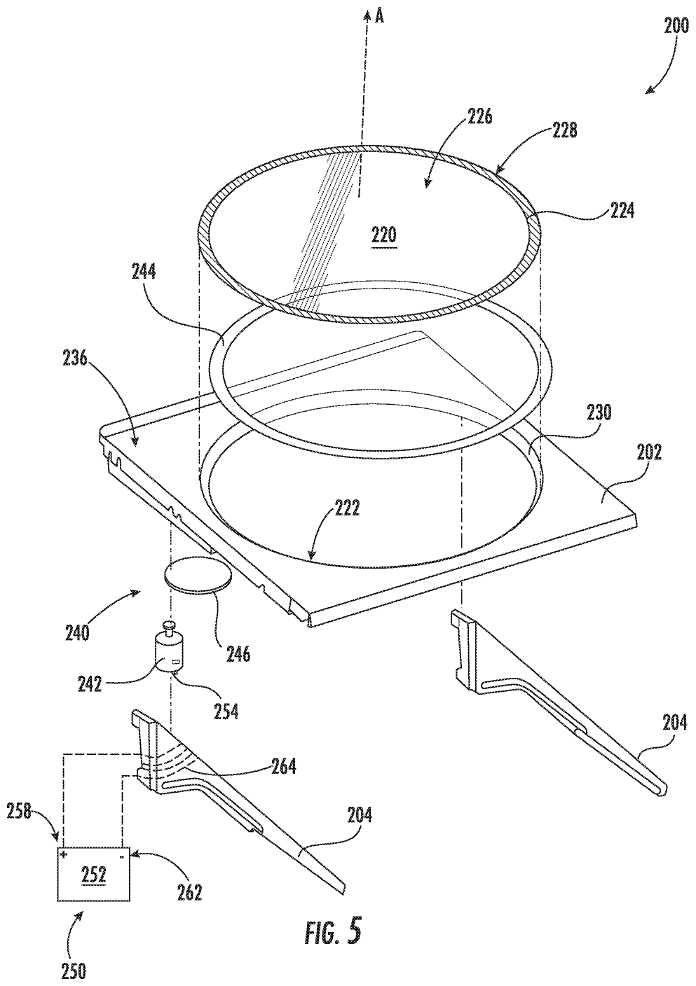

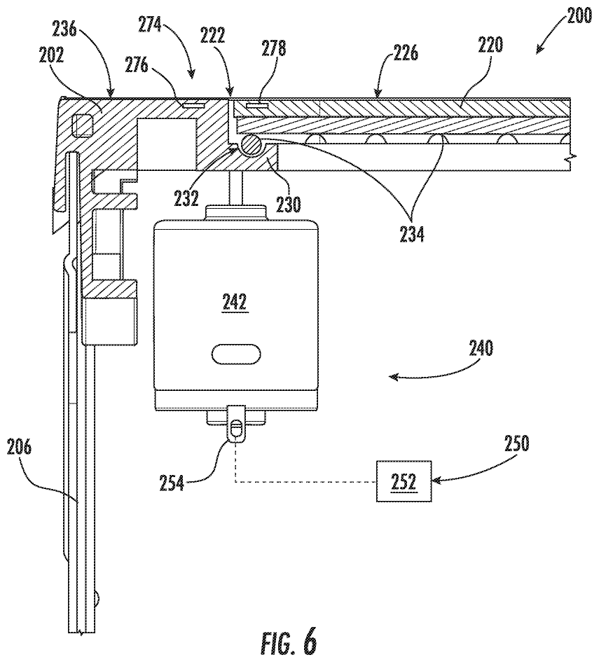

As best illustrated in FIGS. 5 and 6, shelf 202 may define a center aperture 222 that is configured for receiving rotating disk 220. In this regard, center aperture 222 may define an internal diameter that is substantially equivalent to or slightly greater than an outer diameter of rotating disk 220. In this manner, a snug fit between rotating disk 220 and shelf 202 may be achieved to prevent excessive wobble during rotation and/or to prevent food items from falling off of rotating disk 220. It should be appreciated that as used herein, terms of approximation, such as “approximately,” “substantially,” or “about,” refer to being within a ten percent margin of error.

In addition, according to exemplary embodiments, a portion of rotating disk 220 may be treated with a hydrophobic coating 224 (see FIG. 5), e.g., to contain spills. Specifically, for example, a small band of hydrophobic coating 224 may be positioned on a top surface 226 of rotating disk 220, e.g., around a perimeter 228 of rotating disk 220. In this manner, for example, liquids spilled in a center of rotating disk 220 have a tendency to be contained by hydrophobic coating 224 such that they do not fall through center aperture 222. Notably, according to alternative embodiments, rotating disk 220 may further include a ridge or raised lip that extends around a perimeter 228 of rotating this 220 to contain spills.

Shelf 202 may further include a support flange 230 that extends below shelf 202 and toward rotating disk 220 in order to provide vertical support to rotating disk 220. Specifically, support flange 230 extends inward from center aperture 222 and defines a groove 232 for receiving a plurality of bearings 234. Rotating disk 220 may ride on top of bearings 234 to achieve a low friction interface between shelf 202 and rotating disk 220. In addition, support flange 230 and bearings 234 may be sized such that top surface 226 of rotating disk 220 sits flush with a top surface 236 of shelf 202 when rotating disk 220 is installed. Specifically, top surface 226 may be in the same horizontal plane as top surface 236. Although a bearing interface is described herein, it should be appreciated that any other suitable low friction interface may be used according to alternative embodiments.

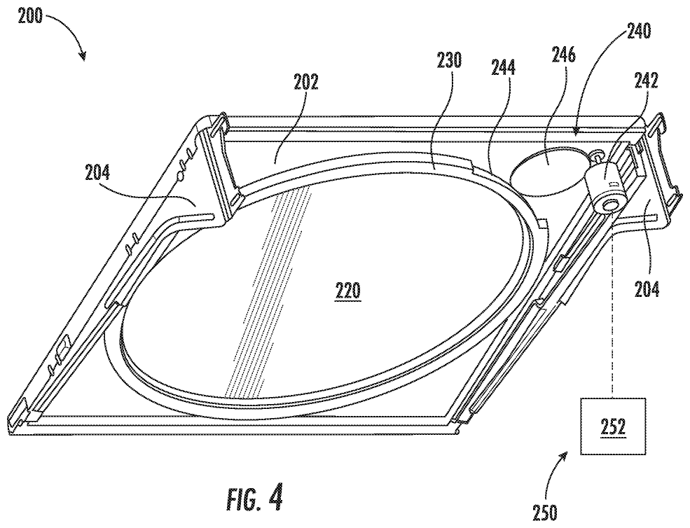

Referring now specifically to FIGS. 4 through 6, rotating shelf assembly 200 may further include a drive mechanism 240 that is mechanically coupled to rotating disk 220 for selectively rotating the rotating disk 220 about an axis of rotation A. Specifically, drive mechanism 240 may include a motor 242 positioned below shelf 202 and being mechanically coupled to rotating disk 220 for driving rotating disk 220. According to the illustrated embodiment, motor 242 is a brushless DC electric motor, e.g., a pancake motor. However, according to alternative embodiments, motor 242 may be any other suitable type or configuration of motor. For example, motor 242 may be an AC motor, an induction motor, a permanent magnet synchronous motor, a stepper motor, or any other suitable type of motor. In addition, drive mechanism 240 may include any other suitable number, types, and configurations of support bearings or transmission mechanisms.

As best illustrated in FIG. 5, drive mechanism 240, i.e., motor 242 is operably coupled with rotating disk 220 through a gear assembly. Specifically, a drive ring 244 is mounted to a bottom surface of rotating disk 220. Specifically, drive ring 244 may be an annular ring with radially extending gear teeth (not shown). According to the illustrated embodiment, drive ring 244 is integrally formed with rotating disk 220 and extends around a perimeter 228 of rotating disk 220. However, it should be appreciated that according to alternative embodiments, drive ring 244 may be a separate component attached to rotating disk 220 or motor 242 could alternatively engage rotating disk 220 through any suitable friction interface, e.g. such as a frictional roller, as opposed to a geared arrangement.

In addition, drive mechanism 240 may include a secondary gear 246 positioned between and mechanically coupling motor 242 to drive ring 244. In this regard, secondary gear 246 may be sized to gear down or slow a disk speed of rotating disk 220 relative to a motor speed. According to the illustrated embodiment, motor 242 is a vertically oriented such that its axis of rotation is parallel to axis of rotation A of rotating disk 220. However, it should be appreciated that according to alternative embodiments, motor 242 and the gear assembly described herein may vary while remaining within the scope of the present subject matter. For example, motor 242 may be horizontally oriented, may directly engage drive ring 244, and may be mounted to shelf 202 in any other suitable manner.

Refrigerator appliance 100 may further include a power supply system 250 for providing electrical power to motor 242. In this regard, for example, power supply system 250 may include a power source 252 that is electrically coupled to motor 242 in any suitable manner. For example, according to an exemplary embodiment, electrical wires may be run from power source 252 directly to electrical terminals 254 on motor 242. However, according to the illustrated embodiment, power supply system 250 may power motor 242 directly through vertical support tracks 206 and/or shelf support brackets 204.

Specifically, power supply system 250 may include a positive bus bar 256 that is electrically coupled to a positive terminal 258 of power source 252. Similarly, power supply system 250 may include a negative bus bar 260 is electrically coupled to a negative terminal 262 of power source 252. Positive bus bar 256 and negative bus bar 260 may be in electrical communication with vertical support tracks 206 at any suitable location for forming electrical connection with shelf support brackets 204 when installed in apertures 208. In this manner, by positioning shelf support brackets 204 on vertical support tracks 206, integrated electrical wiring 264 within shelf support brackets 204 may electrically couple motor 242 to power source 252.

Power supply system 250 as described above is one exemplary method or system for providing electrical power to motor 242 without requiring complex, visible, or exposed wiring systems. However, it should be appreciated that other methods of providing power through shelf support brackets 204 are possible and within scope of the present subject matter. For example, an exemplary system for powering shelves of refrigerator appliances may be constructed in the same or similar manner to the systems described in U.S. application Ser. Nos. 15/422,509 and 15/939,387 to Wantland et al., the disclosures of which are incorporated herein by reference in their entirety for all purposes.

Notably, rotating shelf assembly 200 may include a variety of features for improving the operation of rotating disk 220 and facilitating an improved customer experience related to rotating disk 220. For example, as will be described in more detail below, rotating disk 220 may be configured for rotating when certain events occur, at particular times or dates, based on the weather or outdoor temperature, based on the presence of a particular user or user proximity, based on programming using a mobile phone or other device or application, when the door is opened, when a button is pressed, etc. In addition, for example, rotating shelf assembly 200 may include user-specific functions/features. In this regard, for example, when a particular user give the rotation command, e.g., by pressing a user-specific button, or otherwise approaches or is in proximity with rotating shelf assembly 200, rotating disk 220 may be rotated to a specific angle associated with that user. Exemplary systems and methods of controlling rotating disk 220 will be described below, but are not intended to limit the scope of the present subject matter in any manner.

As shown in FIG. 2, refrigerator appliance 100 may include a door sensor 270 which is generally configured for sensing whether refrigerator door 128 is in the open position or the closed position. For example, door sensor 270 may be a mechanical door switch or a light sensor positioned within fresh food chamber 122 and configured for detecting light when refrigerator door 128 is opened. A controller, e.g., such as appliance controller 156, may be operably coupled to drive mechanism 240 and door sensor 270, and may be generally configured for regulating motor 242 to rotate rotating disk 220 when refrigerator door 128 is opened. In this manner, when a user opens refrigerator door 128, rotating disk 220 may spin a predetermined amount in order to provide a quick view of all items on rotating disk 220. For example, controller 156 may be configured for spinning rotating disk 220 around one full rotation, i.e., 360 degrees. Alternatively, as mentioned above, rotating disk 220 may rotate to a user-specific position to present the user with specific food items.

Other features of rotating shelf assembly 200 may facilitate an improved user experience and control over rotating disk 220. For example, as best illustrated in FIG. 3, rotating shelf assembly 200 may include a user input device 272, e.g. such as input buttons that permit a user to manipulate rotating disk 220. For example, user input device 272 may permit a user to start or stop the rotation of rotating disk 220, to switch the direction of rotation, to increase or decrease the speed of rotation, or to power off rotating shelf assembly 200 altogether.

In order to provide controller 156 with knowledge of the position or angular orientation of rotating disk 220, rotating shelf assembly 200 may further include a position sensor 274, e.g., for determining a zero position of rotating disk 220. For example, according to the illustrated embodiment, position sensor 274 includes a hall-effect sensor 276 mounted at a fixed position on shelf 202 and a magnet 278 positioned on rotating disk 220. As rotating disk 220 is rotated toward a predetermined position, hall-effect sensor 276 can detect the proximity of magnet 278 and controller 156 may determine that rotating disk 220 is in the zero position (or some other known position). Alternatively, any other suitable sensors or methods of detecting the position of rotating disk 220 may be used. For example, motion sensors, camera systems, optical sensors, acoustic sensors, or simple mechanical contact switches may be used according to alternative embodiments.

Referring again to FIG. 1, a schematic diagram of an external communication system 280 will be described according to an exemplary embodiment of the present subject matter. In general, external communication system 280 is configured for enabling communication between a user, an appliance, and a remote server or network. Specifically, according to the illustrated embodiment, refrigerator appliance 100 and/or rotating shelf assembly 200 may communicate with a remote device 282 either directly (e.g., through a local area network (LAN), Wi-Fi, Bluetooth, etc.) or indirectly (e.g., via a network 284), as well as with a remote server (not shown), e.g., to receive notifications, provide confirmations, input operational data, provide position parameters, etc.

In general, remote device 282 may be any suitable device for providing and/or receiving communications or commands from a user. In this regard, remote device 282 may include, for example, a personal phone, a tablet, a laptop computer, or another mobile device. In addition, or alternatively, communication between the appliance and the user may be achieved directly through an appliance control panel (e.g., control panel 152).

In general, network 284 can be any type of communication network. For example, network 284 can include one or more of a wireless network, a wired network, a personal area network, a local area network, a wide area network, the internet, a cellular network, etc. In general, communication with network may use any of a variety of communication protocols (e.g., TCP/IP, HTTP, SMTP, FTP), encodings or formats (e.g. HTML, XML), and/or protection schemes (e.g., VPN, secure HTTP, SSL).

External communication system 280 is described herein according to an exemplary embodiment of the present subject matter. However, it should be appreciated that the exemplary functions and configurations of external communication system 280 provided herein are used only as examples to facilitate description of aspects of the present subject matter. System configurations may vary, other communication devices may be used to communicate directly or indirectly with one or more appliances, other communication protocols and steps may be implemented, etc. These variations and modifications are contemplated as within the scope of the present subject matter.

Referring still to FIG. 1, according to an exemplary embodiment, refrigerator door 128 may include features for detecting a position parameter indicative of a desired shelf position of rotating disk 220. As used herein, the term “position parameter” is generally intended to refer to any data that may be indicative of a desired shelf position, such as a user identity, a user condition, the presence or proximity of a particular user, a time and/or date, weather data, or any other suitable external or internal stimulus or condition. As described in detail below, the position parameter may be used by controller 156 to determine a desired shelf position, e.g., the desired angular orientation of rotating disk 220 to present desired food items.

Refrigerator appliance 100 or rotating shelf assembly 200 may include various sensors and data inputs for receiving position parameters corresponding to shelf positions. For example, as illustrated in FIG. 1, a proximity sensor 286 may be mounted on a front of refrigerator appliance 100 for providing data indicative of a proximity or location of a user of refrigerator appliance 100 or rotating shelf assembly 200. In this regard, for example, proximity sensor 286 may detect the presence of a user in front of refrigerator appliance 100. Thus, when a user approaches refrigerator appliance 100, proximity sensor 286 may provide an indication to controller 156 (e.g., in the form of a position parameter), and controller 156 may then determine a desired shelf position, and rotate rotating disk 220 accordingly.

In addition, it may be desirable in certain circumstances to rotate rotating disk 220 to present food items that are ripe and ready to eat. Alternatively, it may be desirable to present items that are spoiled or have otherwise reached a particular food quality state. Thus, according to exemplary embodiments, refrigerator appliance 100 or rotating shelf assembly 200 may include a food quality sensor 288 (FIG. 3) that is positioned on or proximate shelf 202 for detecting the quality of food items positioned thereon. In this regard, food quality sensor may be any suitable sensor or system of sensors which detect the appearance, color, smell, fumes, or other characteristics of food items that are indicative of the food quality.

In addition, or alternatively, refrigerator appliance 100 or rotating shelf assembly 200 may include a biometric sensor or device 290. In general, biometric sensor 290 may be used to determine any qualitative or quantitative characteristic of a user of rotating shelf assembly 200. For example, biometric sensor 290 may be a fingerprint scanner, a voice recognition system, or a retinal scanner for identifying the user. Once the user is identified, user preferences (e.g., based on programming or historical data) may dictate the desired shelf position and rotating shelf assembly 200 may position rotating disk 220 accordingly. According to alternative embodiments, biometric sensor 290 may detect the temperature of the user and may, for example, rotate refreshing foods or drinks toward a front of rotating shelf assembly 200 if the user's temperature is elevated. It should be appreciated biometric sensor 290 and other sensors described herein may be used to detect any other data or condition that may correspond to or be associated with a preferred shelf position.

In addition, rotating shelf assembly 200 may be operably coupled to a user's remote device 282 to facilitate improved operation and desired shelf rotation. In this regard, for example, rotating shelf assembly 200 may have remote activation features that permit a user to instruct rotating disk 220 to rotate to the desired position using their remote device 282. In this regard, for example, rotating shelf assembly 200 may be Wi-Fi enabled (e.g., via controller 156 or another dedicated controller or wireless communication module) such that it may communicate with a remote device, either directly or through controller 156. Thus, for example, a user may send a command from a mobile phone to spin rotating disk 220 to an angular position associated with that user. Controller 156 may determine which user sent the command (e.g., by identifying the mobile phone) and may operate rotating shelf assembly 200 to properly position rotating disk 220.

According to still other embodiments, controller 156 may detect proximity of or identity of a remote device 282 and position rotating shelf assembly 200 accordingly. For example, if refrigerator appliance 100 detects a door 128 is being opened, controller 156 may determine an identity of the closest remote device 282 and may adjust the position of rotating shelf assembly 200 according to the preferences of the owner of that particular remote device 282. It should be appreciated that other control schemes and system configurations are possible and within the scope of the present subject matter.

Although rotating shelf assembly 200 is described herein as including a single rotating disk 220 mounted at a center of shelf 202, it should be appreciated that variations and modifications may be made to rotating shelf assembly 200 according to alternative embodiments. For example, shelf 202 may form a top of one or more of bins 134 such that drive mechanism 240 or motor 242 is positioned within storage bin 134. Alternatively, shelf 202 may include a plurality of rotating disks 220 which are operably coupled to and driven by a single motor 242 or by multiple motors at any suitable speed. Other variations and modifications are possible and within the scope of the present subject matter.

As one skilled in the art will appreciate, the above described embodiments are used only for the purpose of explanation. Modifications and variations may be applied, other configurations may be used, and the resulting configurations may remain within the scope of the invention. For example, rotating shelf assembly 200 may include any suitable drive mechanism (such as belt drive, pulley systems, etc.), may be positioned at any suitable location within appliance, and may include any other suitable control features or user inputs. One skilled in the art will appreciate that such modification and variations may remain within the scope of the present subject matter.

FIG. 7 depicts certain components of controller 156 according to example embodiments of the present disclosure. Controller 156 can include one or more computing device(s) 156A which may be used to implement methods as described herein. Computing device(s) 156A can include one or more processor(s) 156B and one or more memory device(s) 156C. The one or more processor(s) 156B can include any suitable processing device, such as a microprocessor, microcontroller, integrated circuit, an application specific integrated circuit (ASIC), a digital signal processor (DSP), a field-programmable gate array (FPGA), logic device, one or more central processing units (CPUs), graphics processing units (GPUs) (e.g., dedicated to efficiently rendering images), processing units performing other specialized calculations, etc. The memory device(s) 156C can include one or more non-transitory computer-readable storage medium(s), such as RAM, ROM, EEPROM, EPROM, flash memory devices, magnetic disks, etc., and/or combinations thereof.

The memory device(s) 156C can include one or more computer-readable media and can store information accessible by the one or more processor(s) 156B, including instructions 156D that can be executed by the one or more processor(s) 156B. For instance, the memory device(s) 156C can store instructions 156D for running one or more software applications, displaying a user interface, receiving user input, processing user input, etc. In some implementations, the instructions 156D can be executed by the one or more processor(s) 156B to cause the one or more processor(s) 156B to perform operations, e.g., such as one or more portions of methods described herein. The instructions 156D can be software written in any suitable programming language or can be implemented in hardware. Additionally, and/or alternatively, the instructions 156D can be executed in logically and/or virtually separate threads on processor(s) 156B.

The one or more memory device(s) 156C can also store data 156E that can be retrieved, manipulated, created, or stored by the one or more processor(s) 156B. The data 156E can include, for instance, data to facilitate performance of methods described herein. The data 156E can be stored in one or more database(s). The one or more database(s) can be connected to controller 156 by a high bandwidth LAN or WAN, or can also be connected to controller through one or more network(s) (not shown). The one or more database(s) can be split up so that they are located in multiple locales. In some implementations, the data 156E can be received from another device.

The computing device(s) 156A can also include a communication module or interface 156F used to communicate with one or more other component(s) of controller 156 or refrigerator appliance 100 or rotating shelf assembly 200 over the network(s). The communication interface 156F can include any suitable components for interfacing with one or more network(s), including for example, transmitters, receivers, ports, controllers, antennas, or other suitable components.

Now that the construction of rotating shelf assembly 200 and the configuration of controller 156 according to exemplary embodiments have been presented, an exemplary method 300 of operating a rotating shelf assembly will be described. Although the discussion below refers to the exemplary method 300 of operating rotating shelf assembly 200, one skilled in the art will appreciate that the exemplary method 300 is applicable to the operation of a variety of other system configurations and methods of operation. In exemplary embodiments, the various method steps as disclosed herein may be performed by controller 156.

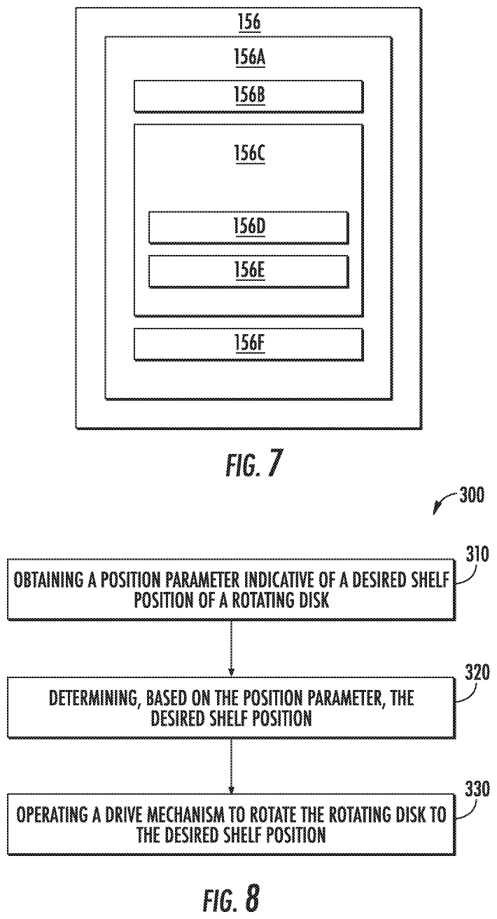

Referring now to FIG. 8, method 300 includes, at step 310, obtaining a position parameter indicative of a desired shelf position of a rotating disk. In this regard, as described above, controller 156 may obtain a position parameter, which may be any data indicative of a user, an external stimulus, external condition, the time, date, or any other data which may be used to determine a desired shelf position.

For example, according to one exemplary embodiment, the position parameter may include at least one of the current time and/or date. Thus, if the obtained timestamp indicates that it is early in the morning, rotating shelf assembly 200 may present orange juice, milk, or creamer for a user's coffee. By contrast, if it is in the middle of the day in the summer, rotating shelf assembly 200 may present refreshing drinks or beverages. According still other embodiments, a user may store common medications on rotating shelf assembly 200 and rotating shelf assembly 200 may be configured for presenting those medications at the desired medication times.

According to still other embodiments, the position parameter may be weather data, such as indoor and/or outdoor temperature or humidity, or other weather-related data. In this regard, controller 156 may communicate with an external server via network 284 to obtain outdoor environmental conditions, e.g., from a web-based weather provider such as the National Weather Service, the National Oceanic and Atmospheric Administration, Weather.com, etc. Alternatively, rotating shelf assembly 200 or controller 156 may be communicatively coupled with a temperature sensor, a humidity sensor, or some other sensor suitable for obtaining data indicative of the weather for determining a corresponding desired shelf position.

As explained above, the position parameter may also be an identity of a user, a proximity of a user, or biometric data associated with a particular user. In this regard, for example, biometric sensor 290 may detect a user's condition or identity, and rotating shelf assembly 200 may be adjusted accordingly 200. According to other embodiments, the quality sensor 288 may provide the position parameter, e.g., based on detected food quality of food items stored on rotating disc 220.

Method 300 further includes, at step 320, determining, based on the position parameter, the desired shelf position. In this regard, the desired shelf position may be an angular position of the shelf, e.g., to present a particular quadrant or section of rotating disc 220 toward a front of refrigerator appliance 100 for easy visibility and accessibility. Notably, as explained above, the desired shelf position is based on the position parameter, such that there is a link or correspondence between the position data obtained by one or more sensors at step 310 and the angular position or desired shelf position obtained at 320. Step 330 includes operating the drive mechanism (e.g., motor 242) to rotate rotating disc 220 to the desired shelf position.

FIG. 8 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 300 are explained using rotating shelf assembly 200 as an example, it should be appreciated that these methods may be applied to the operation of any rotating shelf, such as a standalone rotating shelf assembly, a shelf assembly mounted within an appliance, or a rotating shelf assembly having any other suitable configuration.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotating shelf assembly comprising:
a shelf;
a rotating disk rotatably mounted to the shelf; and
a drive mechanism mechanically coupled to the rotating disk for selectively rotating the rotating disk; and
a controller operably coupled to the drive mechanism, the controller being configured for:
obtaining a position parameter indicative of a desired shelf position of the rotating disk;
determining, based on the position parameter, the desired shelf position; and
operating the drive mechanism to rotate the rotating disk to the desired shelf position.

2. The rotating shelf assembly of claim 1, wherein the position parameter comprises at least one of a time or a date.

3. The rotating shelf assembly of claim 1, wherein the position parameter comprises data indicative of at least one of a user of the rotating shelf assembly or a proximity of the user.

4. The rotating shelf assembly of claim 3, further comprising:
a biometric sensor for identifying the user of the rotating shelf assembly.

5. The rotating shelf assembly of claim 1, wherein the position parameter comprises weather data.

6. The rotating shelf assembly of claim 5, wherein the weather data is received from a remote server.

7. The rotating shelf assembly of claim 1, wherein the position parameter comprises a food quality of one or more items, the rotating shelf assembly further comprising:
a food quality sensor configured for detecting the food quality of the one or more items positioned on the rotating disk.

8. The rotating shelf assembly of claim 1, further comprising:
a wireless communication module in wireless communication with a mobile device for obtaining the position parameter.

9. The rotating shelf assembly of claim 1, wherein the shelf is positioned within a chilled chamber of a refrigerator appliance.

10. The rotating shelf assembly of claim 9, further comprising:
a shelf support bracket for supporting the shelf, wherein the shelf support bracket is configured for receipt within a vertical support track providing a plurality of shelf mounting positions and being electrically coupled to a power source, and wherein the shelf support bracket electrically couples the drive mechanism to the power source when mounted at one of the plurality of shelf mounting positions.

11. The rotating shelf assembly of claim 1, wherein the drive mechanism comprises:
a motor positioned below the shelf and being mechanically coupled to the rotating disk;
a drive ring mounted to a bottom of the rotating disk; and
a secondary gear mechanically coupling the motor to the drive ring, the secondary gear configured for slowing a disk speed relative to a motor speed.

12. The rotating shelf assembly of claim 1, comprising:
a shelf position sensor configured for measuring an angular position of the rotating disk.

13. A method of operating a rotating shelf assembly, the rotating shelf assembly comprising a rotating disk rotatably mounted to a shelf and being mechanically coupled to a drive mechanism, the method comprising:
obtaining a position parameter indicative of a desired shelf position of the rotating disk;
determining, based on the position parameter, the desired shelf position; and
operating the drive mechanism to rotate the rotating disk to the desired shelf position.

14. The method of claim 13, wherein the position parameter comprises at least one of a time or a date.

15. The method of claim 13, wherein the position parameter comprises data indicative of at least one of a user of the rotating shelf assembly or a proximity of the user.

16. The method of claim 13, further comprising:
identifying the user of the rotating shelf assembly using a biometric sensor.

17. The method of claim 13, wherein the position parameter comprises weather data.

18. The method of claim 17, wherein the weather data is received from a remote server.

19. The method of claim 13, wherein the position parameter comprises a food quality of one or more items, the method further comprising:
obtaining the food quality of the one or more items positioned on the rotating disk using a food quality sensor.

20. The method of claim 13, further comprising:
obtaining the position parameter from a mobile device using a wireless communication module in wireless communication with the mobile device.
